(19) United States
(12) Patent Application Publication
(10) Pub. No.: US 2005/0227540 A1
(43) Pub. Date: Oct. 13, 2005

(54) Lamp support for a cabinet

(75) Inventors: Ricardo Regelin, Joinville (BR); Massao mauro Iokomizo, Joinville (BR)

Correspondence Address: DARBY & DARBY P.C., P. O. BOX 5257, NEW YORK, NY, 10150-5257, US

(73) Assignee: MULTIBRAS S.A. ELETRODOMESTICOS, SAO PAULO-SP (BR)

(21) Appl. No.: 10/506,692

(22) PCT Filed: Mar. 14, 2003
(86) PCT No.: PCT/BR03/00038

§ 371 Date: Sep. 3, 2004

(30) Foreign Application Priority Data
Mar. 15, 2002 (BR) PI 0200954-4

(51) Int. Cl. H01K 1/00; H01R 33/22

(52) U.S. Cl. 439/615; 439/661

(57) ABSTRACT

A lamp support for a cabinet including a tubular body (10), which carries adjacent to an end (11), a lamp socket (S) receiving, by an open opposite end (12), a lamp (L) having part of its extension projecting outwardly from said opposite end (12) of the tubular body (10) which incorporates, in a single piece and along part of its peripheral extension, a deflective wall (20) which is dimensioned to surround, laterally and axially and with a certain spacing, the portion of the lamp projecting outwardly from the tubular body (10).

### FIELD OF THE INVENTION

The present invention refers to a lamp support for a cabinet, particularly of the type used inside the cabinets of refrigerators and freezers for the fixation, generally by threading, of incandescent lamps used in said refrigerators.

### BACKGROUND OF THE INVENTION

Some known constructions of refrigerators and freezers present a lamp therewithin, generally of the incandescent type and mounted by threading in a respective socket of a lamp support that is built in the refrigeration cabinet of refrigerators and freezers, generally in an upper portion of said cabinet, above the upper shelf thereof.

In these constructions, in order to avoid that the heat generated by the energized lamp reaches the products under refrigeration inside the refrigeration cabinet, the latter is generally provided with a deflector in the form of a heat deflecting plate, which is mounted to one of the lateral walls and rear wall of said refrigeration cabinet in a position adjacent to the lamp support mounted in said cabinet, and which redirects the heat and the light generated by the energized lamp, protecting the products inside the refrigeration cabinet positioned near said lamp.

While minimizing the heat transfer, such solution presents some disadvantages, such as requiring the provision of an additional element for the assembly of said deflecting plate inside the refrigeration cabinet, which besides increasing the cost of the refrigerator or freezer, increases the assembly time of the latter, since it requires one operation for the assembly of the lamp support and then one operation for the assembly of the deflecting plate.

Another disadvantage of these constructions is that, with use or due to assembly errors, the deflecting plate generally presents a displacement or a swing, impairing not only the efficiency of the heat deflection, but also generating a maintenance cost to the user for repositioning said deflecting plate inside the refrigeration cabinet.

### OBJECTS OF THE INVENTION

Thus, it is an object of the present invention to provide a lamp support for a cabinet of low cost, which dispenses the provision of deflecting plates mounted to the inner walls of the refrigeration cabinet, which reduces the time for the assembly of said support to the refrigeration cabinet, and which maintains its functional quality during the useful life of the refrigerator or freezer, protecting the products under refrigeration from the heat generated by the energized lamp, and maintaining unaltered its assembly condition in the interior of the refrigeration cabinet.

### SUMMARY OF THE INVENTION

This and other objects are attained through a lamp support for a cabinet, including a tubular body which carries, adjacent to one end, a lamp socket, and which receives, by an open opposite end, a lamp having part of its extension projecting outwardly from said opposite end of the tubular body, the opposite end of the tubular body incorporating, in a single piece and along part of its peripheral extension, a deflective wall, which is dimensioned to surround, laterally and axially and with a certain spacing, the portion of the lamp projecting outwardly from the tubular body.

The present invention, by providing the lamp support in a single piece, allows obtaining an efficient deflection of the heat generated by the energized lamp. By being provided in a single piece, the present solution has the advantage of improving the quality of the lighting assembly of the refrigerator or freezer, with the guarantee that this improved assembly condition will be maintained during the useful life of the refrigerator. Such maintenance of the assembly condition results in the maintenance of both the heat deflection condition and the lighting quality within the refrigeration cabinet, avoiding the products under refrigeration from being exposed to the heat generated by the lamp. The lamp support of the present invention further allows reducing the time for the assembly thereof inside the refrigeration cabinet, consequently reducing the cost of this operation.

### BRIEF DESCRIPTION OF THE DRAWINGS

The invention will be described below, with reference to the enclosed drawings, in which:

FIG. 1 illustrates, schematically, a lateral view of a lamp support constructed according to the present invention;

FIG. 2 illustrates, schematically, a lateral view of the lamp support constructed according to FIG. 1, but in an angle offset by 90° in relation to that illustrated in FIG. 1;

FIG. 3 illustrates, schematically, a perspective view of the lamp support of the present invention; and

FIG. 4 illustrates, schematically, a front view of the lamp support of the present invention.

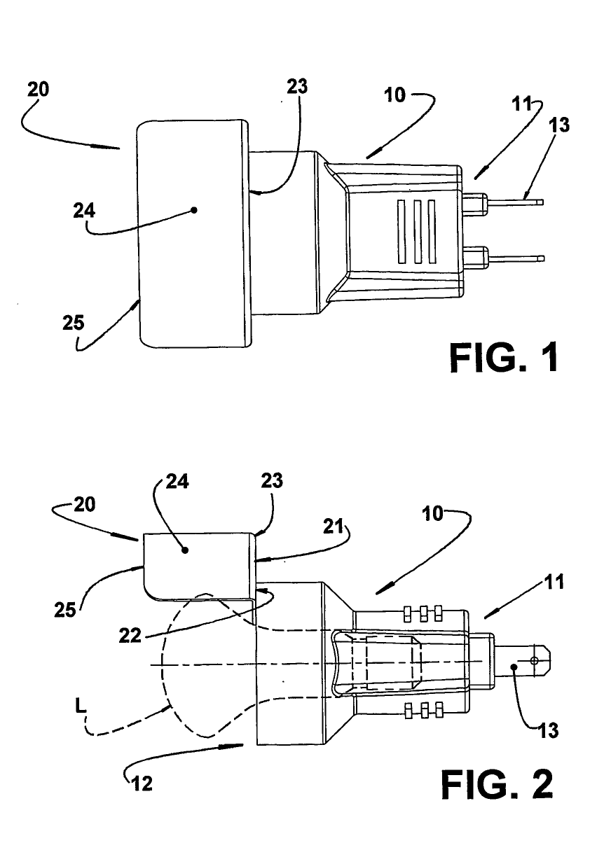

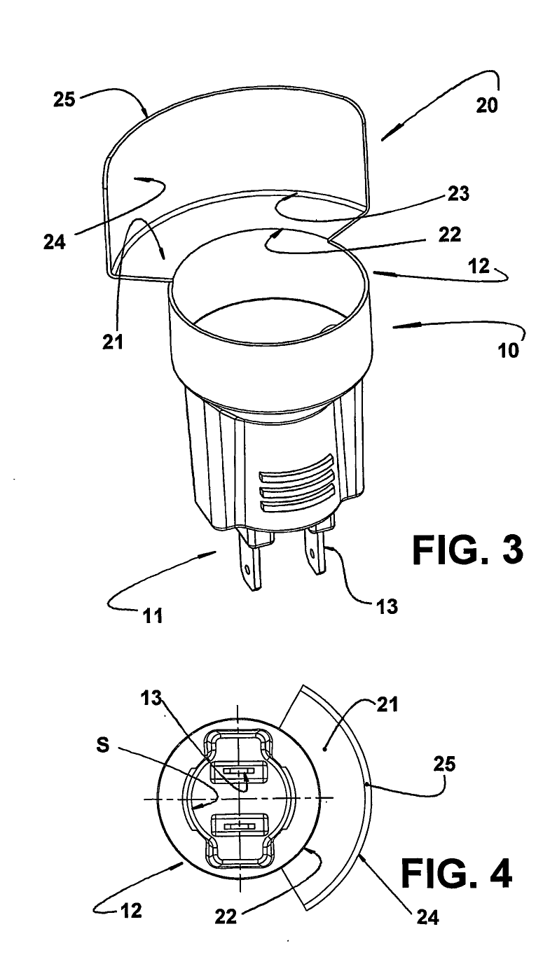

### DESCRIPTION OF THE ILLUSTRATED EMBODIMENT

According to the illustrations, the lamp support for a cabinet of the present invention includes a tubular body 10, for example with a substantially cylindrical shape and carrying, internally and adjacent to an end 11, a lamp socket S, for receiving, by an open opposite end 12 generally with dimensions that are radially enlarged in relation to the end 11, a lamp L with part of its extension projecting outwardly from said opposite end 12 of the tubular body, said lamp L being generally affixed by threading to the inside of the lamp socket.

In the illustrated construction, from the end 11 of the tubular body 10 are projected, externally to the tubular body 10, a pair of electric contact terminals 13, which are internally in electric connection with a contact portion of the lamp socket.

According to the present invention, the opposite end 12 of the tubular body 10 incorporates, in a single piece and along part of its peripheral extension, for example from the peripheral edge of the opposite end 12 of the tubular body 10, a deflective wall 20, which is dimensioned to surround laterally and axially and with a certain spacing, the portion of the lamp L which projects outwardly from the tubular body 10, said deflective wall presenting, for example a circumferential extension between 90° and 180°, more particularly a circumferential extension of about 120°.

In a constructive option of the present invention, the deflective wall 20 presents a radial flap 21 having an internal edge 22 incorporated in the tubular body 10, and an external edge 23 incorporating an arcuated wall portion 24, with a generatrix parallel to the axis of the present lamp support and which laterally and axially surrounds the portion of the lamp L projecting outwardly from the tubular body 10.

According to the illustrations in the enclosed figures, the radial flap 21 is orthogonal to the arcuated wall portion 24, which is coaxial to the axis of the tubular body 10 and projects beyond the axial extension of the lamp L, so that the portion thereof projecting outwardly from the tubular body 10 remains spaced back in relation to a free end edge 25 of said arcuated wall portion 24.

In a preferred constructive option, each of the parts defined by the radial flap 21 and the arcuated wall portion 24 is made of a non-perforated material, defining a continuous body to the respective part.

1. A lamp support for a cabinet including a tubular body (10), which carries adjacent to an end (11), a lamp socket (S) receiving by an open opposite end (12) with dimensions that are radially enlarged in relation to the end (11), a lamp (L) having part of its extension projecting outwardly from said opposite end (12) of the tubular body (10), characterized in that the opposite end (12) of the tubular body (10) incorporates, in a single piece and from and along part of its peripheral extension, a deflective wall (20) which is dimensioned to surround, laterally and axially and with a certain spacing, the portion of the lamp (L) projecting outwardly from the tubular body (10).

2. The support according to claim 1, characterized in that the deflective wall (20) presents a radial flap (21) having an internal edge (22) incorporated to the tubular body (10), and an external edge (23) incorporating an arcuated wall portion (24), with a generatrix parallel to the axis of the lamp support and which laterally and axially surrounds the portion of the lamp (L) projecting outwardly from the tubular body (10).

3. The lamp support according to claim 2, characterized in that the radial flap (21) is orthogonal to the arcuated wall portion (24).

4. The lamp support according to claim 3, characterized in that the arcuated wall portion (24) is coaxial to the axis of the tubular body (10) of the support and is projected beyond the portion of the lamp (L) projecting outwardly from the tubular body (10).

5. The support according to claim 4, characterized in that each of the parts defined by the radial flap (21) and by the arcuated wall portion (24) is non-perforated.

6. The lamp support according to claim 5, characterized in that the deflective wall (20) is incorporated in a single piece to the tubular body (10) from the peripheral edge of the opposite end (12) of the latter.

7. The lamp support according to claim 1, characterized in that the deflective wall (20) presents a circumferential extension between 90° and 180°.
